(19) United States
(12) Patent Application Publication
(10) Pub. No.: US 2010/0253517 A1
(43) Pub. Date: Oct. 7, 2010

(54) ANTITHEFT AND MONITORING SYSTEM FOR PHOTOVOLTAIC PANELS

(75) Inventors: Aimone Balbo Di Vinadio, Chiusa San Michele (Torino) (IT); Mario Palazzetti, Chiusa San Michele (Torino) (IT)

Correspondence Address: PATTERSON & SHERIDAN, L.L.P., 3040 POST OAK BOULEVARD, SUITE 1500, HOUSTON, TX, 77056, US

(73) Assignee: SAVIO S.p.A., Chiusa San Michele (Torino) (IT)

(21) Appl. No.: 12/752,972

(22) Filed: Apr. 1, 2010

(30) Foreign Application Priority Data
Apr. 6, 2009 (EP) 09157373.3

(51) Int. Cl. G08B 13/14

(52) U.S. Cl. 340/568.1

(57) ABSTRACT

An antitheft and monitoring system for a plurality of photovoltaic panels, wherein the panels are connected by means of a connection line to a distribution substation. The monitoring system comprises a first unit associated to the distribution substation, wherein the first unit is designed to generate activation codes, and a plurality of second units associated to the panels, wherein each of the second units is designed to inhibit operation of the respective panel in the absence of the activation code for a pre-set period. Furthermore, each second unit is selectively activatable via a unique activation code generated by the first unit. The antitheft and monitoring system is moreover configured to activate an individual panel selectively by sending onto the connection line the corresponding unique activation code and detecting, via a measuring device, the characteristics of voltage and current of the individual active panel.

### CROSS-REFERENCE TO RELATED APPLICATIONS

This application claims benefit of European patent application number 09157373.3, filed Apr. 6, 2009, which is herein incorporated by reference.

### BACKGROUND OF THE INVENTION

1. Field of the Invention

The present invention relates to an antitheft and monitoring system for photovoltaic panels.

2. Description of the Related Art

Photovoltaic technology has witnessed a considerable expansion in the last few years; in particular, it is very advantageous in remote areas, where said technology has always occupied a strategic role for the distributed generation of electrical energy. However, since they are in the majority of cases sites that are not presided over, they are exposed to a high risk of theft of the photovoltaic panels.

The idea of providing an antitheft system that will prevent operation of the photovoltaic panel when this is detached from the supply line is known, for example, from the international patent application No. WO 97/42664.

This document describes an antitheft device for photovoltaic panels connected by means of a connection line to a distribution line. In particular, the antitheft device comprises a first unit, associated to the distribution line, and a second unit, associated to the panel. The first unit is designed to generate an activation code, and the second unit is designed to inhibit operation of the panel in the absence of said activation code.

In photovoltaic plants with a high number of panels, there arises the need to have available a monitoring function that will enable identification of the panels that present an anomalous behaviour in order to programme interventions of cleaning and/or replacement thereof.

### SUMMARY OF THE INVENTION

The object of the present invention is to provide an antitheft system that will also enable monitoring of photovoltaic panels and will be simple, reliable, and inexpensive.

According to the present invention, said object is achieved by a monitoring system having the characteristics that form the subject of claim 1. The present invention also regards a corresponding procedure.

The present invention advantageously exploits the characteristics of the antitheft device to provide also the monitoring function. In this way, i.e., re-using the hardware already installed, the possibility of performing the operations of monitoring and diagnostics is achieved without requiring installation of a dedicated system.

The antitheft device can be applied to any photovoltaic panel, for example during its processing step (lamination), and this excludes any possibility of tampering with or removal of the antitheft device, without damaging the photovoltaic panel irreparably.

As will emerge clearly from the ensuing description, by appropriately managing an antitheft system that inhibits operation of the panels in the absence of an activation code it is possible to carry out monitoring of a photovoltaic field.

One of the main characteristics of the present invention lies precisely in the combination of the functions of antitheft device and monitoring system. Said functions use the same hardware as regards the panels and centralized hardware for the monitoring, which is in turn used for driving the inverter that connects the field of photovoltaic panels to the electric-power mains. The monitoring hardware could also have on board a GPS system for preventing theft of the panels that are combined to the inverter.

### BRIEF DESCRIPTION OF THE DRAWINGS

Further characteristics and advantages of the invention will emerge from the ensuing description with reference to the annexed drawings, which are provided purely by way of non-limiting example and in which:

FIG. 1 shows an example of photovoltaic plant equipped with an antitheft device;

FIG. 2 shows an example of positioning of the antitheft device within a photovoltaic panel;

FIG. 3 shows in detail the connection of the antitheft device between the cells that form the photovoltaic panel;

FIG. 4 is a cross-sectional view of a portion of panel;

FIG. 5 shows an example of architecture of the monitoring system;

FIG. 6 shows in detail the field of panels of FIG. 5; and

FIGS. 7, 8 and 9 show three different embodiments of the monitoring system.

### DETAILED DESCRIPTION

Described in detail in the first part of the description is operation of the antitheft device. Described, instead, in the second part of the description is operation of the monitoring system that uses the aforesaid antitheft device for the purposes of diagnostics of the individual panels that make up the photovoltaic plant.

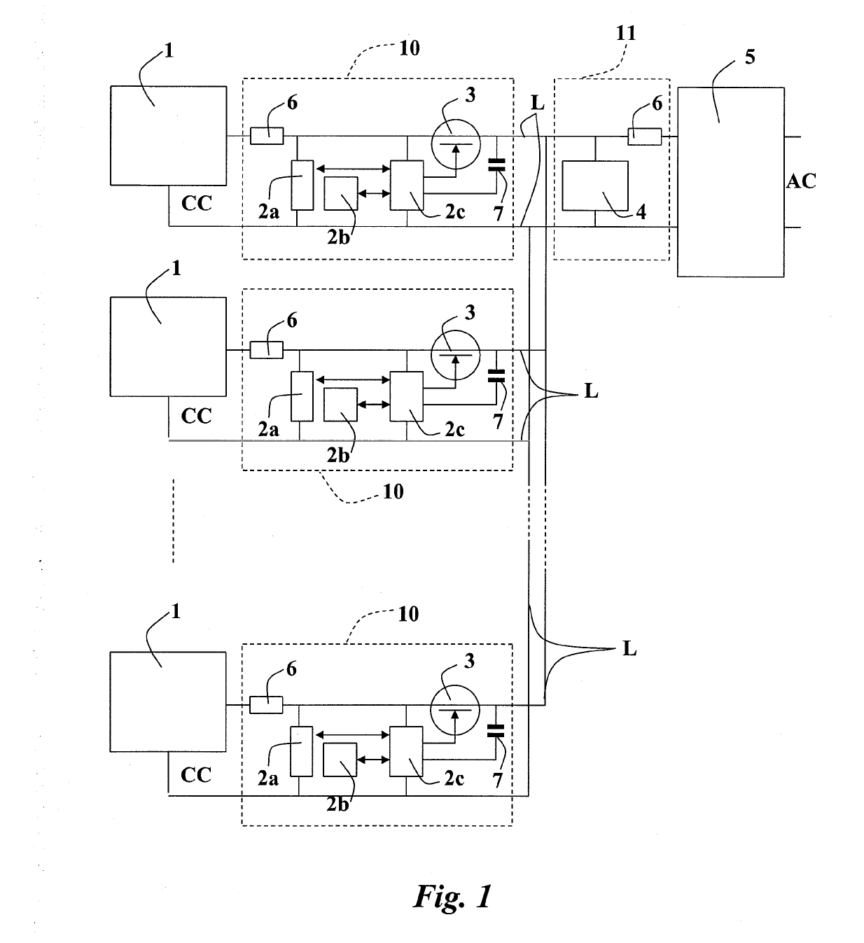

With reference to FIG. 1, an antitheft device for photovoltaic panels 1 connected by means of a connection line L to a distribution substation 5 comprises a first unit 11, associated to the distribution substation 5, and a plurality of second units 10, associated to the panels 1. The first unit 11 is designed to generate an activation code 4 and each of the second units 10 is designed to inhibit operation of the respective panel 1 in the absence of the activation code 4.

Once again with reference to FIG. 1, a plurality of photovoltaic panels 1 are connected in parallel to the two conductors of a connection line, designated as a whole by L, to form a photovoltaic plant.

The energy produced by a photovoltaic panel 1 is in the form of d.c. current CC. To transform the d.c. current CC into a.c. current AC it is necessary to introduce into the plant an inverter device, designated by the reference number 5 in FIG. 1. In all the cases where d.c. current CC is usable directly, the inverter is not present. In the sequel of the text, however, we shall continue to refer to the inverter to indicate a circuit site in which the unit 4 will be inserted.

The antitheft device used comprises a first unit 11 associated to the distribution substation 5 on the plant side, and a plurality of second units 10 associated to the panels 1.

The first unit 11 comprises a code generator 4, which generates an activation code and with pre-set cadence sends it onto the conductors of the connection line L, and an inductance 6 that serves to prevent the high-frequency signal generated by the code generator 4 from propagating downstream of the inverter 5 and upstream of the panels 1.

Once again with reference to FIG. 1, an example of embodiment of the second unit 10 comprises a counter 2a, a memory element 2b, a logic unit 2c, and a switch 3. There are moreover present an inductance 6, which serves to prevent the signal generated by the code generator 4 from propagating to the photovoltaic panel 1, and a capacitor 7, which serves to carry the high-frequency signal generated by the code generator 4 to the logic unit 2c.

The memory element 2b stores inside it a copy of the activation code for decoding using the code that arrives on the connection line L. The memory element 2b is preferably a ROM (Read-Only Memory), and the activation code can be written and personalized by the user during installation or in the factory, which will have to communicate the code to the user.

The counter 2a, inside each panel 1, serves to mark the wait time of the activation code.

The code generator 4 sends, at periodic intervals, the activation code on the line L. The logic unit 2c processes the code stored using the activation code present on the connection line L to activate the switch 3. The logic unit 2c is configured for resetting the counter 2a in the case of positive outcome of the decoding operation.

In the case of negative outcome of the decoding operation, the counter 2b is not reset by the logic unit 2c and continues to count until it reaches a pre-set configuration. This situation arises, for example, when the panel is taken away from the plant and does not receive the activation code within the pre-set wait time. At this point, the logic unit 2c issues a command for opening of the switch 3 to deactivate operation of the respective panel 1. The switch 3 can, for example, be a FET (Field-Effect Transistor).

Hence, each second unit 10 inhibits operation of the respective panel 1 in the absence of the activation code 4 for a pre-set period.

The activation code does not have to be particularly complex but must ensure security so as to speed up the step of decoding performed by the logic unit 2c and limit costs. The activation code is not always present on the connection line L but is sent thereon by the code generator 4 with a pre-set cadence. The code will be encrypted in such a way that it will be difficult to decode.

The second units 10, which together with the first unit 11 perform the function of antitheft device, are associated to the panels. The second units 10 can be external or else, for greater security, can be integrated within the photovoltaic panels themselves.

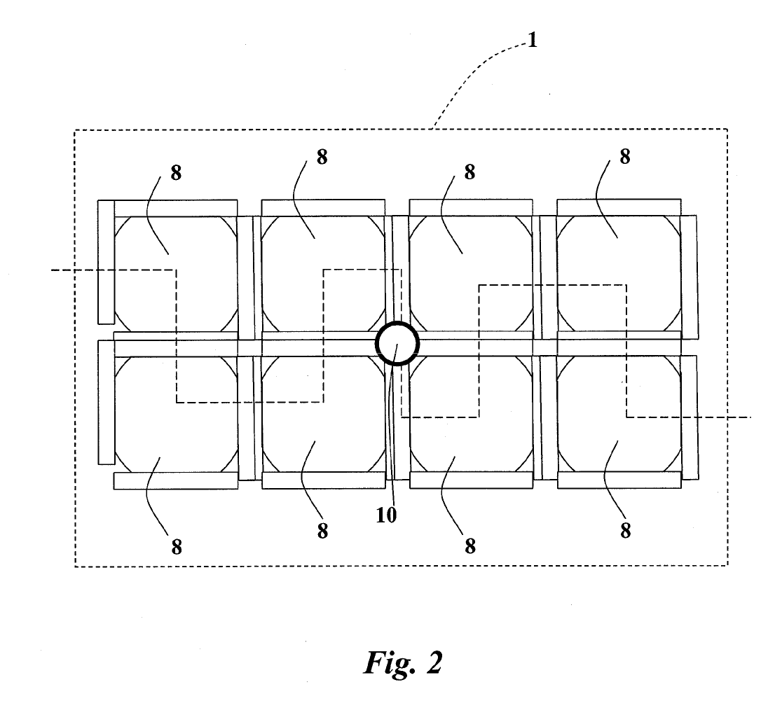

FIG. 2 shows, for example, a second unit 10 integrated within a photovoltaic panel 1 so as to exclude any possibility of tampering therewith or removal thereof without damaging the panel. This characteristic can in any case be obtained by positioning the second unit 10 in such a way as to damage the panel if the latter is tampered with.

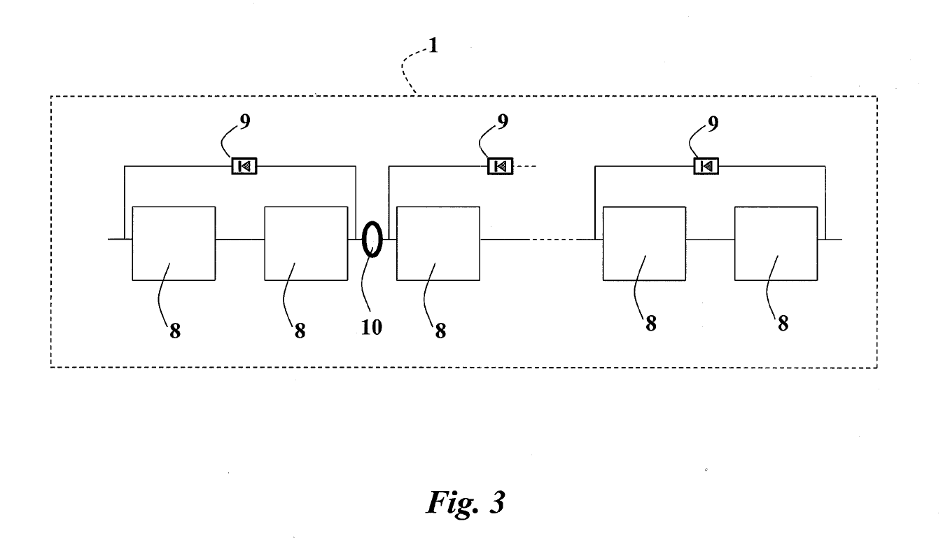

In FIGS. 2 and 3, it may be noted that each photovoltaic panel 1 comprises a plurality of photovoltaic cells, designated by the reference number 8, connected together in series.

Each photovoltaic cell 8 is obtained starting from a cylindrical bar of silicon with circular cross section. A thin lamina is obtained from the bar and is then cut so as to form a square cell with corners rounded off. This serves to optimize arrangement of the cells alongside one another within a panel so as to have the largest possible surface of the panel coated with cells.

With particular reference to FIG. 3, in order to guarantee continuity of the electrical connection of the entire photovoltaic panel 1, by-pass diodes 9 are provided, connected in parallel to groups of cells connected in series. This serves to prevent the phenomena of obscuration due to the presence of leaves, insects, or objects that obscure a photovoltaic cell 8, rendering it in effect an open circuit.

In the examples illustrated in FIGS. 2 and 3, the second unit 10 is positioned so as not to be by-passed by the diodes 9.

In particular, the second unit 10 behaves as a whole as a short circuit when the switch 3 is closed, i.e., when the panel is connected to the plant and receives with pre-set cadence the activation code, and as an open circuit when the panel is disconnected from the plant. This behaviour is very advantageous during installation of the panels because it guarantees safety of the installers. The antitheft device functions hence also as a device for the protection of the person responsible for installation when the panels 1 are being installed.

The antitheft device is supplied by the photovoltaic panels that make up the plant. In the absence of sunlight it does not function. When the panels are illuminated by sunlight, the switch 3 conducts and the counter 2b starts counting. When the logic unit 2c of a panel 1 receives the activation code on the connection line L, it decodes it and, in the case of a positive result, resets the counter 2a, producing the first activation.

In particular, the second unit 10 behaves as an enabling switch that authorizes the respective photovoltaic panel 1 to produce current.

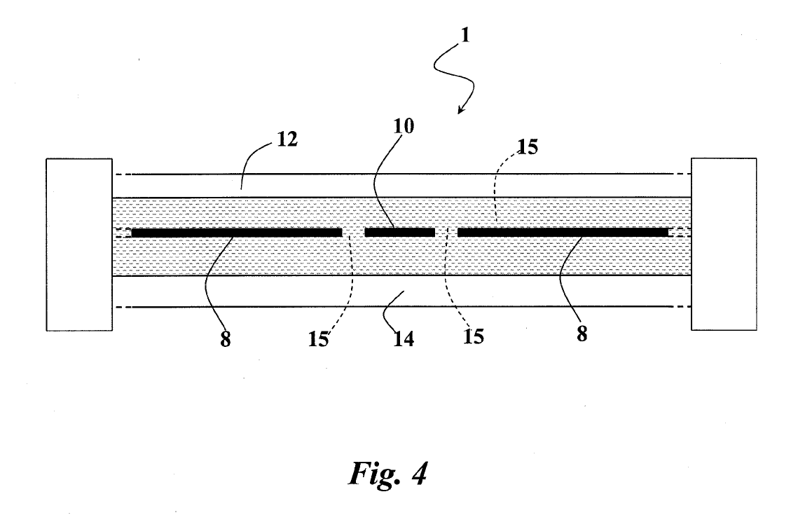

With particular reference to FIG. 4, a photovoltaic panel 1 has a sandwich structure, with a bottom layer 14 made of sheet metal or glass, an intermediate layer 15 made of EVA (ethyl vinyl acetate) resin, which has the function of encapsulating the cells 8, as well as a function of ensuring adhesion between the cells 8, and a top layer 12 made of glass. The second unit 10 could, for example, be embedded in the intermediate layer made of EVA.

Since the first unit 11, which is usually well protected in a masonry structure or in the distribution substation, could be stolen together with the panels 1, it is necessary for it to be in turn protected with another type of antitheft device.

Starting from the photovoltaic plant described previously, in which each panel is equipped with a unit 10, which behaves as enabling switch that authorizes the respective photovoltaic panel 1 to produce current, with an appropriate management it is possible to detect the voltamperometric characteristics of each panel. The characteristics of operation of each panel, correlated to the insulation, can be used for driving the inverter. This enables surveillance of operation of each individual panel and maximization of the efficiency of the entire photovoltaic plant, moreover supplying a remote system with the operating information.

In particular, the same antitheft device can be used to activate/deactivate selectively each individual panel 1 and obtain a voltage/current characteristic to be used for the purposes of diagnostics (for identifying the panels in the plant that present a low efficiency and for intervening, for example, to clean or replace them).

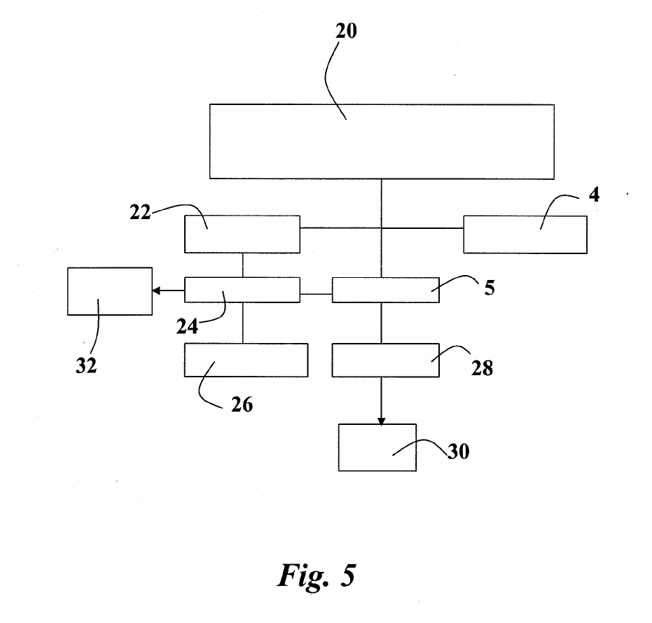

With reference to FIG. 5, a field of photovoltaic panels is designated as a whole by the reference number 20. Each of the panels of the field 20 is equipped with a local unit, which, together with a central unit, forms the antitheft device described previously.

The monitoring system described herein is able to activate and/or deactivate selectively each individual photovoltaic panel 1 within the plant 20. To be able to do this, associated to each panel 1 is a unique activation code different from the activation code of the other panels. The activation code of each panel is stored in the corresponding memory element 2b present in the second unit 10, associated to the panel 1.

The code generator 4, set in the distribution substation 5, generates cyclically the different activation codes in order to activate/deactivate all the panels 1 selectively.

Under normal operating conditions, the code generator 4 generates cyclically all the activation codes and sends them with a given cadence onto the conductors of the connection line L. Each activation code activates a single panel 1, and the respective counter 2a starts its counting to mark out the wait time of sending of the next activation code. Hence, in the normal condition of operation, all the panels 1 are active and produce energy, which is sent to the network 30 through the inverter 5. Between the inverter 5 and the network 30 there exists a protection system 28, which has the purpose of connecting the photovoltaic plant 20 in a secure way to the network 30.

The protection system 28 comprises a BOS (Balance Of System) parameter that takes into account all the losses due to junctions, cables, connections, transformer or metering apparatuses, etc. If, for example, the BOS is 85% (which represents the average of what occurs in plants that do not present a particularly complex structure), it means that the overall losses of solar energy transformed into a.c. current amounts to 15%.

In this situation, if a panel 1 is removed from the plant 20, after a short time operation of said panel is inhibited in so far as the unit 10 does not receive the respective activation code. Hence, the antitheft function is maintained.

Before starting a monitoring session, the system deactivates all the panels 1 of the plant 20 by sending a particular deactivation code or else by waiting for the count of all the counters 2a to run out, without sending new activation codes.

Once all the panels 1 have been deactivated, the code generator 4 generates a single activation code and sends it onto the conductors of the connection line L, activating the corresponding panel 1, which starts to conduct and to produce energy. In this way, at that moment just one panel 1 is connected to the inverter 5.

The monitoring system moreover envisages a measuring device 22 for detecting the characteristics of the active panel, i.e., measuring the voltage and the current supplied by the individual panel 1 to the inverter 5.

The information gathered for each individual panel 1 is processed by a processor 24, which is able to detect an overall voltage/current characteristic. For instance, the overall characteristic of the entire field is represented by the sum of the characteristics of the individual panels 1.

To speed up scanning of monitoring of the entire plant, the monitoring system can send a deactivation signal to the active panel as soon as the operation of measuring performed by the device 22 is completed, without waiting for the cyclic time set by the corresponding counter 2a to elapse.

The processor 24 sends said characteristic to the inverter 5, which is able to optimize the efficiency of the photovoltaic field 20 by acting on the working point of the system, i.e., by varying the input impedance that the inverter 5 presents to the field 20.

There may moreover be present peripherals 32 connected to the processor 24 in order to enable interaction of the monitoring system with the operators.

In a preferred embodiment, there is moreover provided a photovoltaic sensor 26, which is oriented in the same way as the panels 1 and uses a photosensitive element identical to the one used by the panels themselves and serves to complete the information detected by providing a term of comparison. In particular, if at a certain instant the sun is clouded over, it is reasonable to expect a lower production of energy. The sensor 26 hence serves to identify these situations properly. Consequently, in such situations a low efficiency of a panel will be attributed to atmospheric causes and not to any malfunctioning of the panel itself, and no physical intervention will be required on the panel 1 in question.

Available for each system is a layout or a list, which, on the basis of the activation code, enables determination of the physical position of the individual panel within the plant. In this way, once it has been ascertained that a given panel presents problems (for example, a low efficiency) it is possible to physically intervene on the panel itself.

The activation code hence performs two different functions: one of protection, in so far as it serves as activation code for the antitheft system; and the other for unique identification of the panels for the monitoring system.

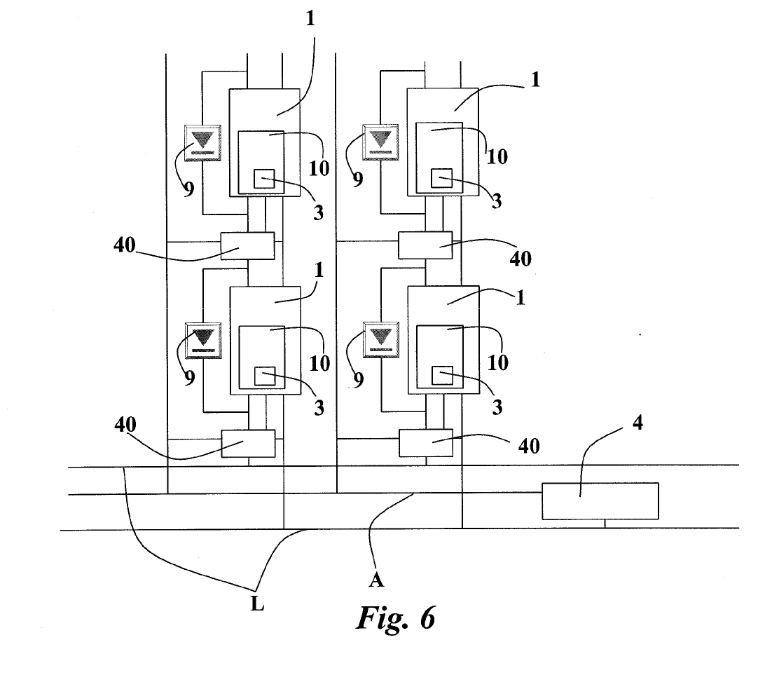

Represented in FIG. 6 are two series of panels 1, connected in parallel with respect to the connection line L. In each series, the panels are instead connected together in series configuration. As may be seen from FIG. 6, associated to each panel 1 is a by-pass diode 9, connected in parallel to the panel itself, which enables the current generated upstream of a panel to bypass said panel if it is inhibited or broken.

As already mentioned previously, each panel 1 contains inside it a unit 10 designed to block, via the switch 3, operation of the panel if it is not cyclically activated by the corresponding activation code transmitted on the connection line L. In some alternative embodiments, the activation codes can travel on a dedicated line A.

Set between the connection line L and each panel 1 is a junction box 40, through which the code transmitted by the unit 11 transits. In particular, with reference to FIG. 1, the junction box 40 comprises the inductance 6, which serves to prevent the signal generated by the code generator 4 from propagating to the photovoltaic panel 1, and the capacitor 7, which has the purpose of bringing the high-frequency signal generated by the code generator 4 to the logic unit 2c.

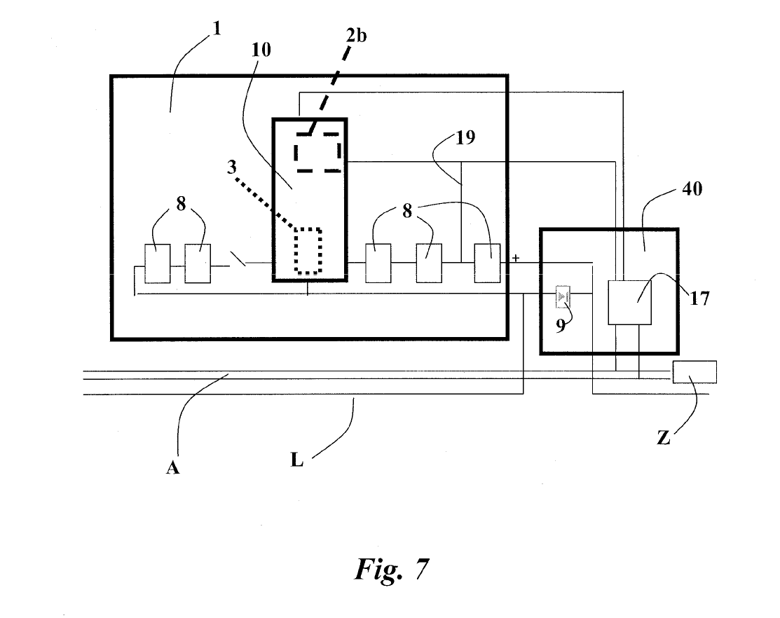

Illustrated in FIGS. 7 to 9 are three different embodiments of the monitoring system.

In FIGS. 7 to 9, parts, elements, or components that are identical or equivalent to parts, elements, or components already described with reference to the preceding FIGS. 1 to 6, are designated by the same references, which renders repetition of the corresponding description superfluous.

The junction box 40 can draw from the activation signal the energy that serves to supply the unit 10.

Furthermore, it may be envisaged to supply the unit 10 directly, via the line 19, within the panel 1, using the energy supplied by the cells 8. In this case, the cells 8 must be illuminated by sunlight or must receive energy from the junction box 40, which draws it from the signal that carries the activation code.

With reference to FIG. 7, the activation signals can be transmitted on the dedicated line A (the line is closed on its characteristic impedance Z to prevent phenomena of reflection of the signal). In this particular case, within the junction box 40 there is a demodulator 17 with high-impedance input that has the purpose of demodulating the signal that arrives on the dedicated line A.

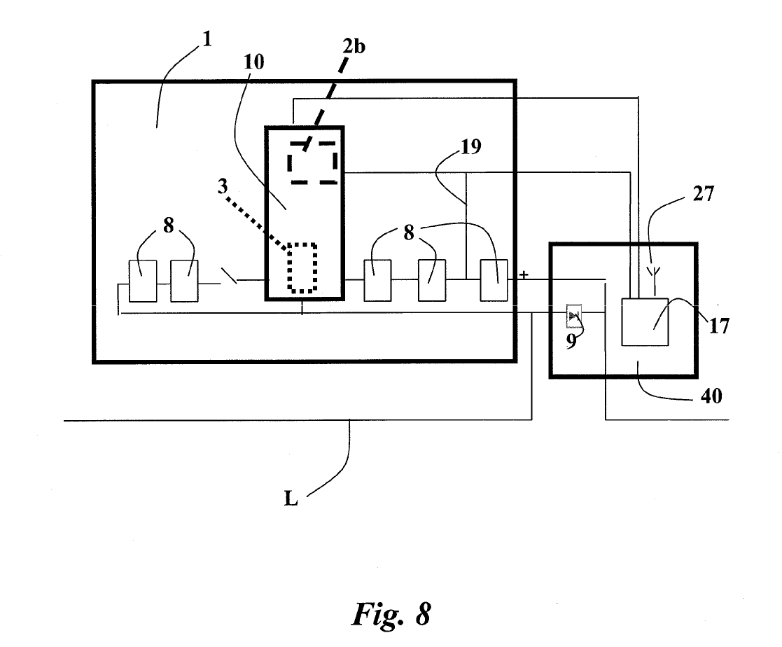

Alternatively, the activation signals can be transmitted via radio, as illustrated in FIG. 8; in this case, the demodulator 17 receives the wireless signal through the antenna 27, and the supply of the circuits of the unit 10 must be drawn necessarily from the panel 1 through the line 19.

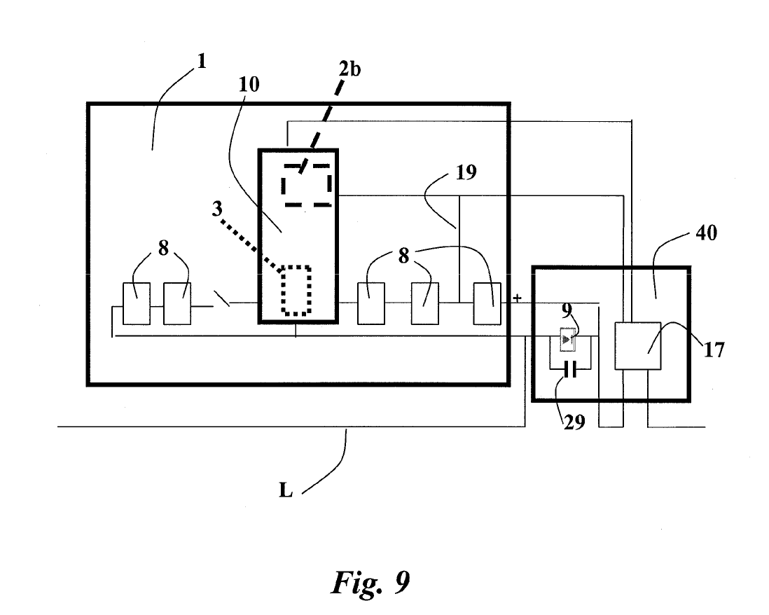

Finally, in FIG. 9 the signal travels directly on the power line. In this case, the element 17 is a transformer that transfers the a.c. component freely and retrieves the information (i.e., the high-frequency signal). With this type of arrangement, it is necessary to envisage a capacitor 29 connected in parallel to the by-pass diode to enable passage of the high-frequency signal (at high frequencies the capacitor behaves as a short circuit).

It is moreover possible to envisage a monitoring system that functions in a conjugate way; i.e., it performs its monitoring function by deactivating a single panel at a time, to keep production of energy active.

The reference to “one embodiment” in the context of this description is intended to signify that a particular configuration, structure, or characteristic described in relation to the embodiment is comprised in at least one embodiment. Hence, phrases such as “in one embodiment” that may be present in various points of this description, do not necessarily refer to the same embodiment. Furthermore, particular conformations, structures, or characteristics can be combined adequately in one or more embodiments.

The references used herein are merely adopted for convenience and hence do not define the sphere of protection or the scope of the embodiments.

1. An antitheft and monitoring system for a plurality of photovoltaic panels, wherein the panels are connected by means of a connection line to a distribution substation, the monitoring system comprising a first unit associated to the distribution substation, wherein said first unit is designed to generate activation codes, and a plurality of second units associated to the panels, wherein each of said second units is designed to inhibit operation of the respective panel in the absence of the activation code for a pre-set period, wherein each of the second units is selectively activatable via a unique activation code generated by said first unit.

2. The antitheft and monitoring system according to claim 1, wherein said first unit comprises a generator of activation codes, which generates a plurality of different activation codes and sends them with a pre-set cadence onto the connection line.

3. The antitheft and monitoring system according to claim 2, wherein each of said second units comprises:
a memory element, designed to store inside it a unique activation code of the respective panel;
a counter, designed to count the wait time of the aforesaid unique activation code;
a logic unit, designed to process the activation code present on the connection line with the one stored in the memory element, wherein said logic unit is configured for resetting the counter element in the case of positive outcome of the decoding operation; and
a switch, governed by the logic unit, designed to deactivate operation of the panel when the counter element reaches a pre-set configuration.

4. The antitheft and monitoring system according to claim 3, wherein the generator of activation codes of said first unit is designed to generate a deactivation code, and in that the logic unit of each of said second units is designed to control opening of the corresponding switch for deactivating operation of the panel when it receives said deactivation code.

5. The antitheft and monitoring system according to claim 4, further comprising a measuring device for detecting the characteristics of voltage and current of an individual active panel, and a processor module, designed to detect an overall characteristic starting from the characteristics of the individual panels, detected via said measuring device and to send said overall characteristic to the distribution substation, wherein said distribution substation varies its input impedance according to said overall characteristic.

6. The antitheft and monitoring system according to claim 5, further comprising a photovoltaic sensor, oriented to the same way as the panels and with a photosensitive element identical to that of the panels for supplying additional information regarding the atmospheric conditions of insulation.

7. The antitheft and monitoring system according to claims 3, wherein:
said memory element is a ROM;
said switch is a FET; and
each photovoltaic panel comprises a plurality of photovoltaic cells connected together in series, and said second unit being set between two photovoltaic cells.

8. The antitheft and monitoring system according to claim 7, wherein each photovoltaic panel comprises a plurality of by-pass diodes arranged in parallel to a plurality of photovoltaic cells, and in that each second unit is positioned so as not to be by-passed by the by-pass diodes.

9. The antitheft and monitoring system according to claim 1, wherein each second unit of said plurality is supplied by the respective photovoltaic panel.

10. The antitheft and monitoring system according to claim 1, wherein the activation codes are transmitted:
on a dedicated line closed on its characteristic impedance to prevent phenomena of reflection;
via radio; or
directly on the connection line.

11. The antitheft and monitoring system according to claim 1, wherein said distribution substation comprises an inverter unit equipped with an antitheft device based upon GPS technology.
